(19) United States
(12) Patent Application Publication
(10) Pub. No.: US 2007/0230813 A1
(43) Pub. Date: Oct. 4, 2007

(54) Error diffusion processing circuit and method, and plasma display device

(75) Inventors: Akira Yamamoto, Tokyo (JP); Masaya Tajima, Higashimurayama (JP); Toshio Ueda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU HITACHI PLASMA DISPLAY LIMITED, Kawasaki (JP)

(21) Appl. No.: 11/358,740

(22) Filed: Feb. 22, 2006

(30) Foreign Application Priority Data
Feb. 22, 2005 (JP) 2005-046200

(51) Int. Cl. G06K 9/36

(52) U.S. Cl. 382/252

(57) ABSTRACT

An error diffusion processing circuit is provided which has a separator dividing digital pixel data of an object pixel into high bits and low bits, and making the low bits error data, multiplier circuits multiplying transmission error data of a plurality of adjacent pixels by adjacent pixel weighting coefficients, and outputting weighted transmission error data, a first adder circuit performing addition on the basis of the error data of the object pixel, and the weighted transmission error data of adjacent pixels, and outputting an added value and a carry value, a second adder circuit adding the high bit pixel data of the object pixel and the carry value, and outputting output pixel data, and a correction circuit correcting transmission error data of an adjacent pixel to the error data of the object pixel or data obtained by performing arithmetic processing of it when the transmission error data of the adjacent pixel is 0, and outputting it to the corresponding multiplier circuit.

### CROSS-REFERENCE TO RELATED APPLICATIONS

This application is based upon and claims the benefit of priority from the prior Japanese Patent Application No. 2005-046200, filed on Feb. 22, 2005, the entire contents of which are incorporated herein by reference.

### BACKGROUND OF THE INVENTION

1. Field of the Invention

The present invention relates to error diffusion processing circuit and method, and a plasma display device.

2. Description of the Related Art

In patent document 1 (Japanese Patent Application Laid-Open No. 2000-227778), a plasma display device which has an error diffusion processing circuit is described. The error diffusion processing circuit separates m bits of pixel data into low i bits for error data and high (m-i) bits for display data, and makes the error data diffused to adjacent pixels. In addition, in patent document 2 (Japanese Patent Application Laid-Open No. 2003-271091), a display device which has an error diffusion processor is described.

The error diffusion processing circuit may be unable to express an image faithfully depending on a display pattern. In particular, since luminance difference between gradations is easily found due to characteristics of people's eyes at the time of low gradation display, noise of the error diffusion processing circuit is conspicuous easily, and hence, this becomes a cause of degrading display quality.

### SUMMARY OF THE INVENTION

The present invention aims at providing error diffusion processing circuit and method, and a plasma display device which can enhance display quality.

According to an aspect of the present invention, an error diffusion processing circuit is provided which has a separator which divides digital pixel data of an object pixel into high bits and low bits, and makes the low bits error data, multiplier circuits which multiply transmission error data of a plurality of adjacent pixels by adjacent pixel weighting coefficients, and output weighted transmission error data, a first adder circuit which performs addition on the basis of the error data of the object pixel, and the weighted transmission error data of adjacent pixels, and outputs an added value and a carry value, a second adder circuit which adds the high bit pixel data of the object pixel and the carry value, and outputs output pixel data, and a correction circuit which corrects transmission error data of an adjacent pixel to the error data of the object pixel or data obtained by performing arithmetic processing of it when the transmission error data of the adjacent pixel is 0, and outputs it to the corresponding multiplier circuit.

### BRIEF DESCRIPTION OF THE DRAWINGS

FIG. 1 is a diagram showing a structural example of a plasma display device according to an embodiment of the present invention;

FIG. 2 is an exploded perspective view showing a structural example of a plasma display panel according to this embodiment;

FIG. 3 is a diagram showing a structural example of one frame of an image;

FIG. 4 is a schematic diagram of a usual error diffusion processing circuit;

FIG. 5 is a diagram showing a target pixel PA for error diffusion processing, and its adjacent pixels PB, PC, PD, and PE;

FIG. 6 is a list showing transmission error data;

FIG. 7 is a diagram showing an example of a low gradation display pattern with which display quality deteriorates;

FIG. 8 is a schematic diagram showing a structural example of an error diffusion processing circuit according to this embodiment;

FIG. 9 is a diagram showing a target pixel PA for error diffusion processing, and its adjacent pixels PB, PC, PD, and PE;

FIG. 10 is a list showing transmission error data; and

FIG. 11 is a list showing an example of selection signal creating conditions of a selection signal generation circuit.

### DETAILED DESCRIPTION OF THE PREFERRED EMBODIMENTS

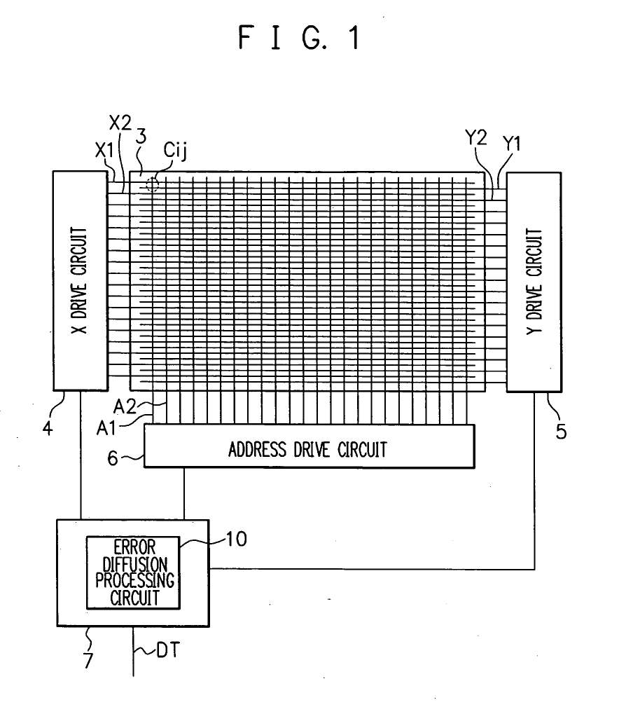

FIG. 1 is a diagram showing a structural example of a plasma display device according to an embodiment of the present invention. A control circuit 7 has an error diffusion processing circuit 10, and inputs the pixel data DT of a two-dimensional image. The control circuit 7 performs gamma conversion processing and the like on the basis of, for example, the 10-bit pixel data DT, and generates 16-bit pixel data, for example. A plasma display panel 3 can display 8-bit pixel data, for example. The error diffusion processing circuit 10 performs gradation conversion of the 16-bit pixel data to 8-bit pixel data.

The control circuit 7 controls an X drive circuit 4, a Y drive circuit 5, and an address drive circuit 6 on the basis of the pixel data which the error diffusion processing circuit 10 outputs. The X drive circuit 4 supplies a predetermined voltage to a plurality of X electrodes X1, X2 . . . . Hereafter, each of the X electrodes X1, X2 . . . or a general term of them will be called an X electrode Xi, and i means a subscript. The Y drive circuit 5 supplies a predetermined voltage to a plurality of Y electrodes Y1, Y2 . . . . Hereafter, each of the Y electrodes Y1, Y2 . . . or a general term of them will be called a Y electrode Yi, and i means a subscript. The address drive circuit 6 supplies a predetermined voltage to a plurality of address electrodes A1, A2 . . . . Hereafter, each of the address electrodes A1, A2 . . . or a general term of them will be called an address electrode Aj, and j means a subscript. The drive circuits 4 to 6 drive the plasma display panel 3.

In the plasma display panel 3, the Y electrode Yi and the X electrode Xi form rows horizontally extended in parallel, and the address electrode Aj forms a column extended vertically. The Y electrode Yi and the X electrode Xi are arranged by turns vertically. The Y electrode Yi and the address electrode Aj form a two-dimensional matrix with i rows and j columns. A display cell Cij is formed with an intersection of the Y electrode Yi and the address electrode Aj, and the adjacent X electrode Xi corresponding to it. This display cell Cij responds to a pixel, and the plasma display panel 3 can display a two-dimensional image.

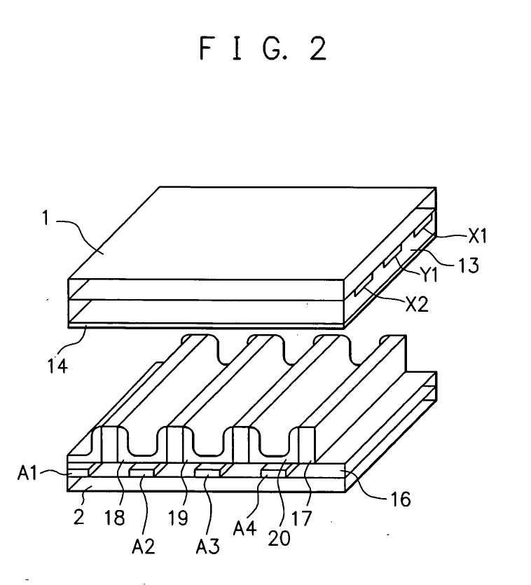

FIG. 2 is an exploded perspective view showing a structural example of the plasma display panel 3 according to this embodiment. The X electrode Xi and the Y electrode Yi are formed on a front glass substrate 1. On them, a dielectric layer 13 for insulation from a discharge space is coated. Further on it, an MgO (magnesium oxide) protective layer 14 is coated. On the other hand, the address electrode Aj is formed on a rear glass substrate 2 which is arranged with facing the front glass substrate 1. Thereon, a dielectric layer 16 is coated. Further thereon, phosphors 18 to 20 are coated. The red, blue, and green phosphors 18 to 20 are arrayed and coated by every color in stripes on internal surfaces of bulkheads (rib) 17. Discharge between the X electrode Xi and the Y electrode Yi excites the phosphors 18 to 20, and each color emits light. In a discharge space between the front glass substrate 1 and the rear glass substrate 2, an Ne+Xe Penning gas or the like is enclosed.

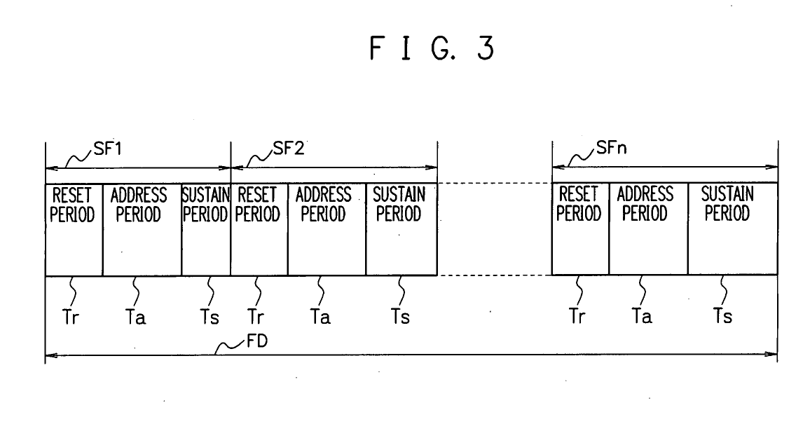

FIG. 3 is a diagram showing a structural example of one frame FD of an image. The one frame FD is formed of a first subframe SF1, a second subframe SF2 . . . an n-th subframe SFn. This n is 10, for example, and is equivalent to a number of bits of the gradation. Hereafter, each of subframes SF1, SF2 . . . or a general term of them is called a subframe SF.

Each subframe SF is constructed of a reset period Tr, an address period Ta, and a sustaining (maintenance discharge) period Ts. In the reset period Tr, the display cell Cij is initialized. In the address period Ta, it is possible to select emission or non-emission of each display cell Cij by address discharge between the address electrode Aj and the Y electrode Yi. Specifically, it is possible to select emission or non-emission of a desired display cell Cij by applying scanning pulses sequentially to the Y electrodes Y1, Y2, Y3, Y4 . . . and applying an address pulse to the address electrode Aj with corresponding to the scanning pulses. In the sustaining period Ts, emission is performed by performing sustaining discharge between the X electrode Xi and the Y electrode Yi of the selected display cell Cij. In each subframe SF, an emission frequency (length of the sustaining period Ts) by the sustaining pulse between the X electrode Xi and the Y electrode Yi differs. Thereby, a gradation value can be determined.

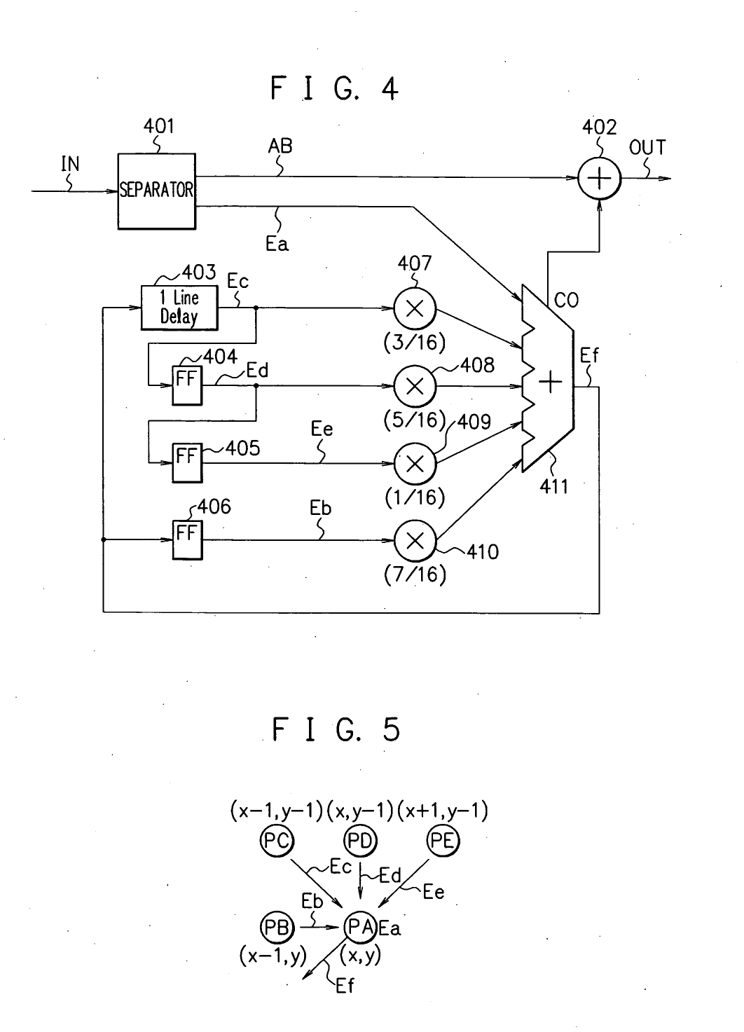

FIG. 4 is a schematic diagram of a usual error diffusion processing circuit 10, and FIG. 5 is a diagram showing a target pixel PA for error diffusion processing, and its adjacent pixels PB, PC, PD, and PE. Coordinates of the object pixel PA are (x, y) Here, in coordinates (X, Y), the X-axis shows a horizontal direction and the Y-axis shows a vertical direction. The adjacent pixel PB is a left pixel of the object pixel PA, and its coordinates are (x−1, y). The adjacent pixel PC is an upper left pixel of the object pixel PA, and its coordinates are (x−1, y−1). The adjacent pixel PD is an upper pixel of the object pixel PA, and its coordinates are (x, y−1). The adjacent pixel PE is an upper right pixel of the object pixel PA, and its coordinates are (x+1, y−1). The error diffusion processing advances in the right horizontal direction from the pixel in the upper left corner of a two-dimensional image, then, it advances in the right horizontal direction from the left end of a horizontal line thereunder, and similarly, it advances to the pixel in the lower right corner of the two-dimensional image.

A separator 401 separates digital pixel data IN of the object pixel PA into high bit pixel data AB and low bit pixel data Ea. The pixel data IN is p bits, the high bit pixel data AB is m bits, and the low bit pixel data Ea is n bit, and these has the relation of p=m+n. For example, p is 16, and m and n are 8. The low bit pixel data Ea is error data of the object pixel PA.

A one-line delay circuit 403 delays previous transmission error data Ef by one line to output transmission error data Ec of the adjacent pixel PC. That is, the one-line delay circuit 403 stores one line of past transmission error data Ef. A flip-flop 404 delays the transmission error data Ec by one pixel to output transmission error data Ed of the adjacent pixel PD. A flip-flop 405 delays the transmission error data Ed by one pixel to output transmission error data Ee of the adjacent pixel PE. A flip-flop 406 delays the previous transmission error data Ef by one pixel to output transmission error data Eb of the adjacent pixel PB.

A multiplier circuit 407 multiplies transmission error data Ec by, for example, 3/16 as an adjacent pixel weighting coefficient to output weighted transmission error data. A multiplier circuit 408 multiplies transmission error data Ed by, for example, 5/16 as an adjacent pixel weighting coefficient to output weighted transmission error data. A multiplier circuit 409 multiplies transmission error data Ee by, for example, 1/16 as an adjacent pixel weighting coefficient to output weighted transmission error data. A multiplier circuit 410 multiplies transmission error data Eb by, for example, 7/16 as an adjacent pixel weighting coefficient to output weighted transmission error data.

An adder circuit 411 adds the error data Ea and the output data of the multiplier circuits 407 to 410 to output an added value Ef and a carry value CO. The added value Ef becomes transmission error data of the object pixel PA, and is used for the error diffusion processing of other pixels. All of six error data Ea to Ef are n bits (e.g., 8 bits). The carry value CO is 1 bit, and it is set to 1 when there is carry, and it is set to 0 when there is no carry.

An adder circuit 402 adds the high bit pixel data AB of the object pixel PA and the carry value CO to output pixel data OUT of the object pixel PA. The output pixel data OUT is m bits (e.g., 8 bits), and becomes a value which is the same value as the pixel data AB, or a value obtained by adding one to the pixel data AB.

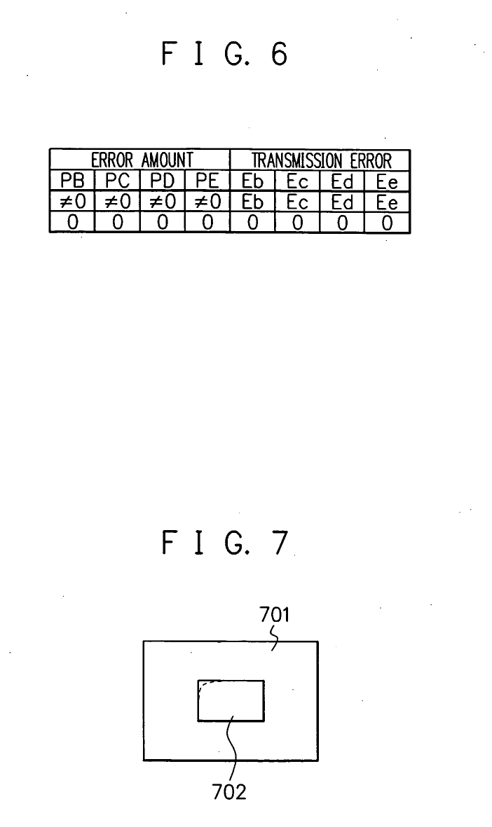

FIG. 6 is a list showing transmission error data. When the transmission error data Eb to Ee of the adjacent pixels PB to PE are 0, they are used for the error diffusion processing of the object pixel PA as the transmission error data Eb to Ee being 0. In addition, when the transmission error data Eb to Ee of the adjacent pixels PB to PE are not 0, the non-zero transmission error data Eb to Ee are used for the error diffusion processing of the object pixel PA.

Next, problems of the error diffusion processing circuit in FIG. 4 will be explained. When the transmission error data Eb to Ee of the adjacent pixels are 0, even if the error data Ea is a maximum (all the eight bits are 1), the carry value CO is set to zero. Therefore, the pixel data OUT of the object pixel PA becomes the same as the pixel data AB.

FIG. 7 is a diagram showing an example of a low gradation display pattern with which display quality deteriorates. In a region 701, black where both of the pixel data AB and Ea are zero is displayed. In a region 702, the high bit pixel data AB is 0, and low bit pixel data Ea is a large value. Originally, it is preferable that the square area 702 is displayed in the black region 701. However, there is a problem that, when the error diffusion processing is performed, the upper left corner portion of the region 702 becomes round because the transmission error data of the adjacent pixels are 0 or small. In particular, since luminance difference between gradations is easily found due to characteristics of people's eyes when this phenomenon arises at the time of low gradation display, this is conspicuous easily, and hence, this leads to the degradation of display quality.

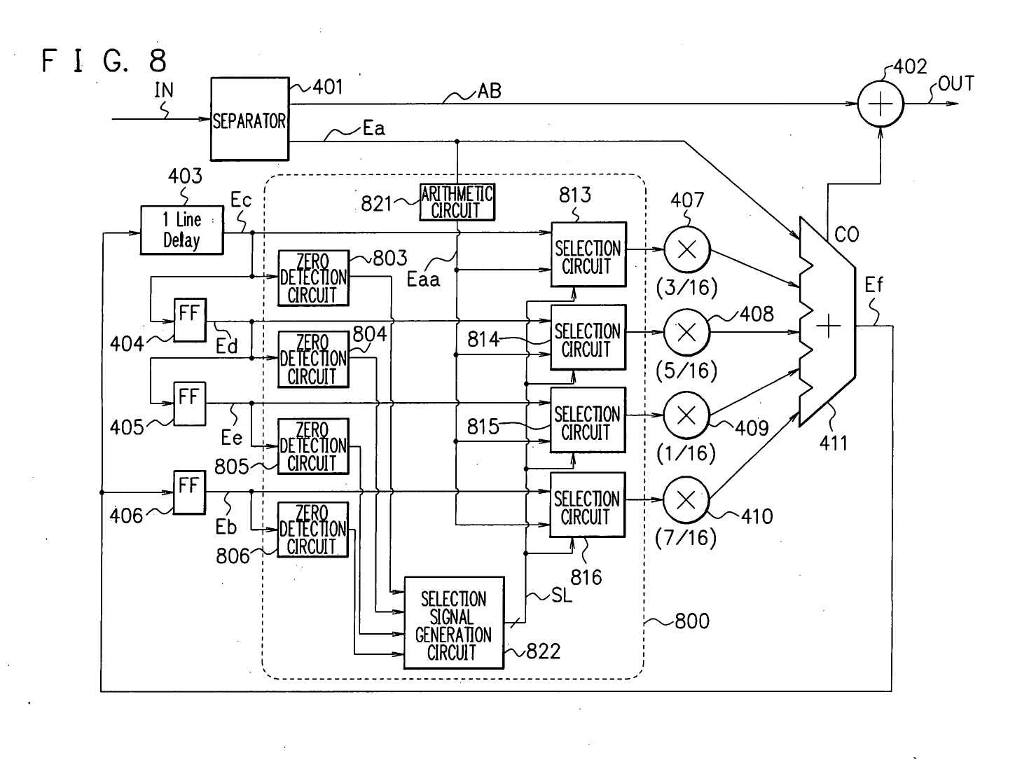

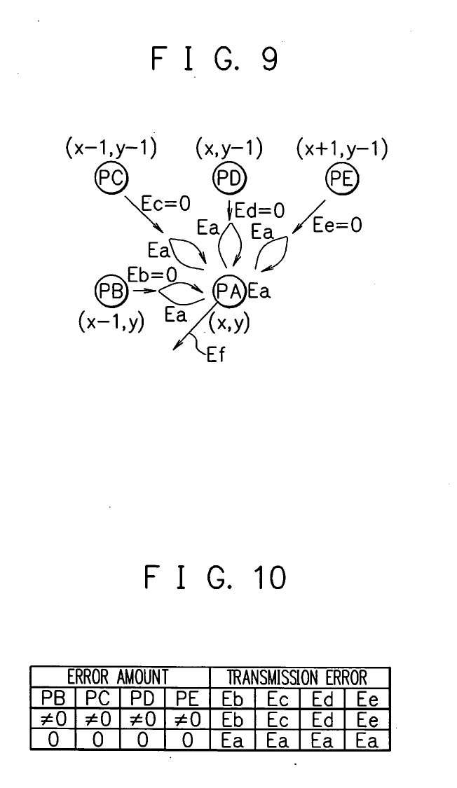

FIG. 8 is a schematic diagram showing a structural example of the error diffusion processing circuit 10 according to this embodiment, and FIG. 9 is a diagram showing the target pixel PA for error diffusion processing, and its adjacent pixels PB, PC, PD, and PE. Coordinates of the object pixel PA and its adjacent pixels PB, PC, PD, and PE are the same as those in FIG. 5. The error diffusion processing advances in the right horizontal direction from the pixel in the upper left corner of a two-dimensional image, then, it advances in the right horizontal direction from the left end of a horizontal line thereunder, and similarly, it advances to the pixel in the lower right corner of the two-dimensional image. FIG. 8 is obtained by adding a correction circuit 800 to FIG. 4.

A separator 401 separates the digital pixel data IN of the object pixel PA into the high bit pixel data AB and low bit pixel data Ea. The pixel data IN is p bits, the high bit pixel data AB is m bits, and the low bit pixel data Ea is n bit, and these has the relation of p=m+n. For example, p is 16, and m and n are 8. The low bit pixel data Ea is error data of the object pixel PA. The transmission error data Eb to Ee are error data transferred to the object pixel PA from the adjacent pixels PB to PE.

A one-line delay circuit 403 delays the previous transmission error data Ef by one line to output the transmission error data Ec of the adjacent pixel PC. That is, the one-line delay circuit 403 stores the one line of past transmission error data Ef. A flip-flop 404 delays the transmission error data Ec by one pixel to output the transmission error data Ed of the adjacent pixel PD. A flip-flop 405 delays the transmission error data Ed by one pixel to output the transmission error data Ee of the adjacent pixel PE. A flip-flop 406 delays the previous transmission error data Ef by one pixel to output transmission error data Eb of the adjacent pixel PB.

An arithmetic circuit 821 is not necessarily required. First, the case where there is no arithmetic circuit 821 will be explained. In that case, error data Eaa has the same value as the error data Ea.

A zero detection circuit 803 detects whether the transmission error data Ec is 0, a zero detection circuit 804 detects whether the transmission error data Ed is 0, a zero detection circuit 805 detects whether the transmission error data Ee is 0, a zero detection circuit 806 detects whether the transmission error data Eb is 0, and they output the results to a selection signal generation circuit 822. The selection signal generation circuit 822 inputs the four detected results, and outputs four selection signals SL to four selection circuits 813 to 816, respectively.

According to the selection signal SL, when the transmission error data Ec is not 0, the selection circuit 813 selects the transmission error data Ec to output it to the multiplier circuit 407. But, when the transmission error data Ec is 0, the selection circuit 813 selects the error data Eaa to output it to the multiplier circuit 407.

According to the selection signal SL, when the transmission error data Ed is not 0, the selection circuit 814 selects the transmission error data Ed to output it to the multiplier circuit 408. But, when the transmission error data Ed is 0, the selection circuit 814 selects the error data Eaa to output it to the multiplier circuit 408.

According to the selection signal SL, when the transmission error data Ee is not 0, the selection circuit 815 selects the transmission error data Ee to output it to the multiplier circuit 409. But, when the transmission error data Ee is 0, the selection circuit 815 selects the error data Eaa to output it to the multiplier circuit 409.

According to the selection signal SL, when the transmission error data Eb is not 0, the selection circuit 816 selects the transmission error data Eb to output it to the multiplier circuit 410. But, when the transmission error data Eb is 0, the selection circuit 816 selects the error data Eaa to output it to the multiplier circuit 410.

A multiplier circuit 407 multiplies the output data of the selection circuit 813 by, for example, 3/16 as an adjacent pixel weighting coefficient to output weighted transmission error data. A multiplier circuit 408 multiplies the output data of the selection circuit 814 by, for example, 5/16 as an adjacent pixel weighting coefficient to output weighted transmission error data. A multiplier circuit 409 multiplies the output data of the selection circuit 815 by, for example, 1/16 as an adjacent pixel weighting coefficient to output weighted transmission error data. A multiplier circuit 410 multiplies the output data of the selection circuit 816 by, for example, 7/16 as an adjacent pixel weighting coefficient to output weighted transmission error data.

An adder circuit 411 adds the error data Ea and the output data of the multiplier circuits 407 to 410 to output the added value Ef and carry value CO. The added value Ef becomes transmission error data of the object pixel PA, and is used for the error diffusion processing of other pixels. All of six error data Ea to Ef are n bits (e.g., 8 bits). The carry value CO is 1 bit, and it is set to 1 when there is carry, and it is set to 0 when there is no carry.

An adder circuit 402 adds the high bit pixel data AB of the object pixel PA and the carry value CO to output pixel data OUT of the object pixel PA. The output pixel data OUT is m bits (e.g., 8 bits), and becomes a value which is the same value as the pixel data AB, or a value obtained by adding one to the pixel data AB.

FIG. 10 is a list showing transmission error data. When the transmission error data Eb to Ee of the adjacent pixels PB to PE are 0, the error data Ea is used for the error diffusion processing instead of the transmission error data Eb to Ee. In addition, when the transmission error data Eb to Ee of the adjacent pixels PB to PE are not 0, the non-zero transmission error data Eb to Ee are used for the error diffusion processing as it is.

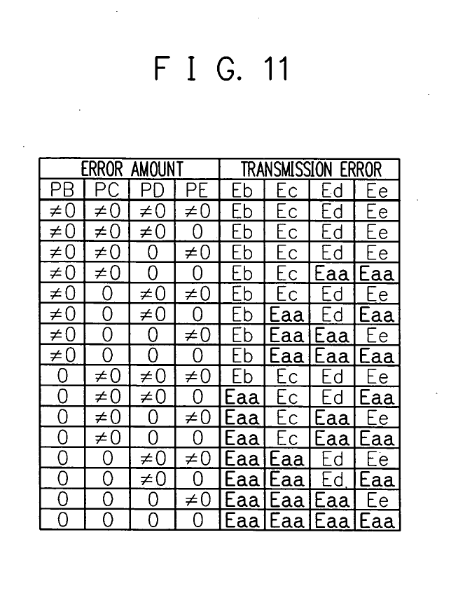

As described above, by detecting whether the transmission error data Eb to Ee of the adjacent pixels PB to PE are 0 to the object pixel PA, and substituting the error data Ea, which the object pixel PA itself has, with the transmission error data Eb to Ee, when the transmission error data Eb to Ee are 0, to perform processing as if there were a transmission error, it becomes possible to lighten and display the upper left corner portion of the display pattern region 702, which should be displayed originally, in FIG. 7. In addition, the selection signal generation circuit 822 may generate the selection signals SL according to the combination of zeros of the transmission error data Eb to Ee of four adjacent pixels PB to PE, as shown in FIG. 11.

FIG. 11 is a list showing an example of selection signal creating conditions of the selection signal generation circuit 822. When each of the transmission error data Eb to Ee is not 0, the selection signal generation circuit 822 outputs the transmission error data Eb to Ee to the multiplier circuits 407 to 410 as it is. When any of the transmission error data Eb to Ee is 0, the selection signal generation circuit 822 outputs the error data Eaa instead of the transmission error data, which is 0, to the corresponding multiplier circuits 407 to 410 when two or more of the transmission error data Eb to Ee of four adjacent pixels PB to PE are 0. When two or more of the transmission error data Eb to Ee of four adjacent pixels PB to PE are not 0, it outputs the transmission error data, which are 0, to the corresponding multiplier circuits 407 to 410 as it is. Thus, it is possible to adjust a frequency of use of the error data Ea (=Eaa) of the object pixel PA by setting of the selection signal creation conditions.

In addition, the arithmetic circuit 821 performs a predetermined operation to the error data Ea, and outputs the error data Eaa. For example, the arithmetic circuit 821 outputs the data Eaa which is obtained by performing bit reversal of the error data Ea, or outputs the data Eaa which is obtained by addition, subtraction, or multiplication of the error data Ea. Thereby, it is possible to adjust an amount of the error data Ea used for the error diffusion processing to adjust a number of pixels lighting in the upper left corner portion of the pattern region 702 in FIG. 7, and to bring the lighting pattern close further to the original.

As described above, according to this embodiment, the correction circuit 800 corrects the transmission error data Eb to Ee of the adjacent pixels PB to PE to the error data Ea of the object pixel PA, or the data Eaa which is obtained by performing the arithmetic processing of it when the transmission error data Eb to Ee of the adjacent pixels PB to PE are 0, and outputs them to the multiplier circuits 407 to 410.

In addition, as shown in FIG. 11, the correction circuit 800 can perform the above-mentioned correction according to the combination of zeros of the transmission error data of a plurality of adjacent pixels. For example, the correction circuit 800 can perform the above-mentioned correction, only when a specific number of the transmission error data are equal to 0 among the transmission error data of a plurality of adjacent pixels.

The correction circuit 800 makes it possible by correcting transmission error data of adjacent pixels to reproduce an original display pattern faithfully and to enhance display quality. In particular, the present invention notably enhances display quality in a low gradation side.

In addition, all the above-mentioned embodiments are only specific examples at the time of implementing the present invention, and the technical scope of the present invention must not be restrictively interpreted by these. That is, the present invention can be implemented in various forms without deviating from its technological idea or its main features.

The present embodiments makes it possible by correcting transmission error data of adjacent pixels to reproduce an original display pattern faithfully and to enhance display quality. In particular, the present invention notably enhances display quality in a low gradation side.

What is claimed is:

1. An error diffusion processing circuit, comprising:
a separator dividing digital pixel data of an object pixel into high bits and low bits, and making the low bits error data;
multiplier circuits multiplying transmission error data of a plurality of adjacent pixels by adjacent pixel weighting coefficients, and outputting weighted transmission error data;
a first adder circuit performing addition on the basis of the error data of the object pixel, and the weighted transmission error data of the adjacent pixels, and outputting an added value and a carry value;
a second adder circuit adding the high bit pixel data of the object pixel and the carry value, and outputting output pixel data; and
a correction circuit correcting the transmission error data of the adjacent pixel to the error data of the object pixel or data obtained by performing arithmetic processing of it when the transmission error data of the adjacent pixel is 0, and outputting it to the corresponding multiplier circuit.

2. The error diffusion processing circuit according to claim 1, wherein there are a plurality of the adjacent pixels; and
wherein the correction circuit performs the correction according to the combination of zeros of transmission error data of the plurality of adjacent pixels.

3. The error diffusion processing circuit according to claim 2, wherein the correction circuit performs the correction only when a specific number of the transmission error data are equal to 0 among the transmission error data of the plurality of adjacent pixels.

4. The error diffusion processing circuit according to claim 1, wherein the correction unit comprises:
zero detection circuits detecting whether transmission error data of the adjacent pixels are 0; and
selection circuits selecting either of transmission error data of the adjacent pixels, or the corrected data, and outputting them to the multiplier circuits according to detected results of the zero detection circuits.

5. The error diffusion processing circuit according to claim 1, wherein the correction circuit corrects transmission error data of the adjacent pixel to data obtained by performing bit reversal of error data of the object pixel when the transmission error data of the adjacent pixel is 0, and outputs it to the corresponding multiplier circuit.

6. The error diffusion processing circuit according to claim 1, wherein the correction circuit corrects transmission error data of the adjacent pixel to data obtained by performing addition, subtraction, or multiplication of error data of the object pixel when the transmission error data of the adjacent pixel is 0, and outputs it to the corresponding multiplier circuit.

7. The error diffusion processing circuit according to claim 2, wherein the correction unit comprises:
zero detection circuits detecting whether transmission error data of the plurality of adjacent pixels are 0; and
selection circuits selecting either of transmission error data of the adjacent pixels, or the corrected data, and outputting them to the corresponding multiplier circuits according to detected results of the zero detection circuits.

8. The error diffusion processing circuit according to claim 7, wherein the correction circuit corrects transmission error data of the adjacent pixel to data obtained by performing bit reversal of error data of the object pixel when the transmission error data of the adjacent pixel is 0, and outputs it to the corresponding multiplier circuit.

9. The error diffusion processing circuit according to claim 7, wherein the correction circuit corrects transmission error data of the adjacent pixel to data obtained by performing addition, subtraction, or multiplication of error data of the object pixel when the transmission error data of the adjacent pixel is 0, and outputs it to the corresponding multiplier circuit.

10. A plasma display device, comprising:
an error diffusion processing circuit according to claim 1;
a plasma display panel displaying an image; and
a drive circuit driving the plasma display panel on the basis of output pixel data which the error diffusion processing circuit outputs.

11. An error diffusion processing method, comprising:
a separation step of dividing digital pixel data of an object pixel into high bits and low bits, and makes the low bits error data;
a correction step of correcting transmission error data of a plurality of adjacent pixels to error data of the object pixel or data obtained by performing arithmetic processing of it when the transmission error data of the adjacent pixels are 0;
a multiplying step of multiplying transmission error data of the adjacent pixels by adjacent pixel weighting coefficients, and outputting weighted transmission error data;
a first adding step of performing addition on the basis of error data of the object pixel, and weighted transmission error data of the adjacent pixels, and outputting an added value and a carry value; and
a second adding step of adding high bit pixel data of the object pixel and the carry value, and outputting output pixel data.

12. The error diffusion processing method according to claim 11, wherein there are a plurality of the adjacent pixels; and
wherein the correction step performs the correction according to the combination of zeros of transmission error data of the plurality of adjacent pixels.

13. The error diffusion processing method according to claim 12, wherein the correction step performs the correction only when a specific number of transmission error data are equal to 0 among the transmission error data of the plurality of adjacent pixels.

14. The error diffusion processing method according to claim 11, wherein the correction step comprises:
a zero detection step of detecting whether transmission error data of the adjacent pixel is 0; and
a selection step of selecting either of transmission error data of the adjacent pixel, or the corrected data according to the zero detection result.

15. The error diffusion processing method according to claim 11, wherein the correction step corrects transmission error data of the adjacent pixel to data obtained by performing bit reversal of error data of the object pixel when the transmission error data of the adjacent pixel is 0.

16. The error diffusion processing method according to claim 11, wherein the correction step corrects transmission error data of the adjacent pixel to data obtained by performing addition, subtraction, or multiplication of error data of the object pixel when the transmission error data of the adjacent pixel is 0.

17. The error diffusion processing method according to claim 12, wherein the correction step comprises:
a zero detection step of detecting whether transmission error data of the plurality of adjacent pixels are 0; and
a selection step of selecting either of transmission error data of the adjacent pixels, or the corrected data according to the zero detection results.

18. The error diffusion processing method according to claim 17, wherein the correction step corrects transmission error data of the adjacent pixel to data obtained by performing bit reversal of error data of the object pixel when the transmission error data of the adjacent pixel is 0.

19. The error diffusion processing method according to claim 17, wherein the correction step corrects transmission error data of the adjacent pixel to data obtained by performing addition, subtraction, or multiplication of error data of the object pixel when the transmission error data of the adjacent pixel is 0.
